(19) United States
(12) Patent Application Publication
(10) Pub. No.: US 2025/0128583 A1
(43) Pub. Date: Apr. 24, 2025

(54) MULTIFUNCTIONAL STORAGE AND PROTECTION SYSTEM

(71) Applicant: IP/Austria Assets Trust, New York, NY (US)

(72) Inventors: Jose Alberto Sanchez, Manhattan Beach, CA (US); Mauricio Rojas Esquivel, Manhattan Beach, CA (US)

(21) Appl. No.: 18/924,266

(22) Filed: Oct. 23, 2024

Related U.S. Application Data
(60) Provisional application No. 63/592,416, filed on Oct. 23, 2023.

(51) Int. Cl. B60J 7/14; B60R 9/06; B60R 13/01

(52) U.S. Cl. CPC B60J 7/141; B60R 9/065; B60R 13/01; B60R 2013/016

(57) ABSTRACT

The technology disclosed herein enables storage and protection for a vehicle having a cargo bed. In a particular example, a multifunctional protection and storage system is provided. The system includes at least two panels and at least one hinge connecting two of the at least two panels. The at least two panels are configured to be arranged in at least two modes selected from a group consisting of a cargo bed cover mode, a cargo bed liner mode, a storage box mode, and a cabin protection mode.

### RELATED APPLICATIONS

This application is related to and claims priority to U.S. Provisional Patent Application 63/592,416, titled “MULTIFUNCTIONAL STORAGE AND PROTECTION SYSTEM,” filed Oct. 23, 2023, and which is hereby incorporated by reference in its entirety.

### TECHNICAL FIELD

The present disclosure relates to the field of vehicle covers, and more specifically, for vehicle covers for truck cargo beds.

### BACKGROUND

Users of conventional pickup trucks may use a cover over the cargo bed of the truck to protect the contents of the bed. However, the protective covers limit the cargo capacity of the truck bed. When the protective cover is removed, it must be stored in the vehicle where it no longer serves a function and takes up cargo space. There is a need for a protective truck bed cover that serves multiple functions and does not significantly reduce cargo capacity.

### SUMMARY

The technology disclosed herein enables storage and protection for a vehicle having a cargo bed. In a particular example, a multifunctional protection and storage system is provided. The system includes at least two panels and at least one hinge connecting two of the at least two panels. The at least two panels are configured to be arranged in at least two modes selected from a group consisting of a cargo bed cover mode, a cargo bed liner mode, a storage box mode, and a cabin protection mode.

These and other objects, features and advantages of the present invention will become more apparent from the following description when taken in connection with the accompanying drawings.

### BRIEF DESCRIPTION OF THE DRAWINGS

FIG. 1 is an illustration of an exemplary embodiment of a multifunction system arranged in a first mode.

FIG. 2 is an illustration of an exemplary embodiment of the multifunction system arranged in a second mode.

FIG. 3 is an illustration of an exemplary embodiment of the multifunction system arranged in a third mode.

FIG. 4 is an illustration of an exemplary embodiment of the multifunction system arranged in a fourth mode.

### DETAILED DESCRIPTION

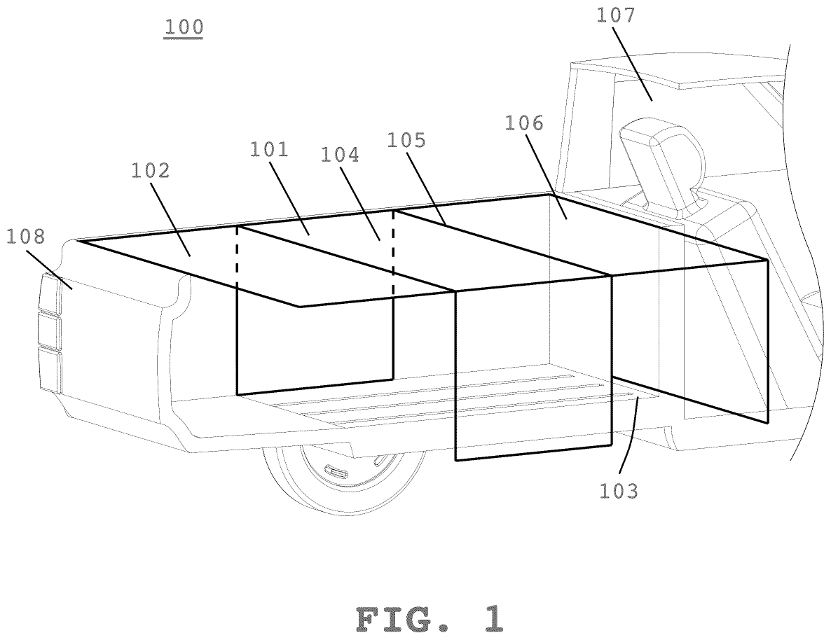

FIG. 1 illustrates a vehicle 100 having a multifunctional protection and storage system 101 positioned on the sidewalls 102 of cargo bed 103. The system 101 comprises a plurality of panels 104 joined by hinges 105. The panels 104 may be arranged in a plurality of modes which serve different functions. FIG. 1 illustrates the system 101 arranged in a first mode serving the function of a cargo bed cover. In the first mode, at least one panel 104 is arranged across the cargo bed 103 in order to protect the contents of the cargo bed 103. In some embodiments of the first mode, additional panels lay in contact with sidewall 102 and/or a midgate 106—which separates the cargo bed 103 and cabin 107—in order to also protect the sidewall 102 and/or midgate 106.

In some embodiments, the panels 104 may be formed from a single layer of a material. The material may be resin such as thermoplastic olefin which provides environmental protection. In other embodiments the panels 104 may be formed from a plurality of layers consisting of a plurality of materials. For example, the layers may comprise a structural inner layer and a protective outer layer. The panels 104 may vary in size based on their function. For example, a panel 104 that covers the cargo bed 103 may be longer than a panel that protects the sidewall 102. In some embodiments, the hinge 105 may be a living hinge made of the same material as panels 104. In other embodiments, at least one hinge 105 may be another type of hinge such as a barrel or bearing hinge. Panels 104 may additionally be selectively connected to other panels by fasteners (not shown). Fasteners may also be used to secure the panels 104 to portions of the vehicle such as a rail on sidewall 102 or a slot in the cargo bed 103. Fasteners may be features molded into panel 104 such as slots, sliders, or rings. Fasteners may also be or conventional fastening mechanisms such as magnets, hook and loop, or straps.

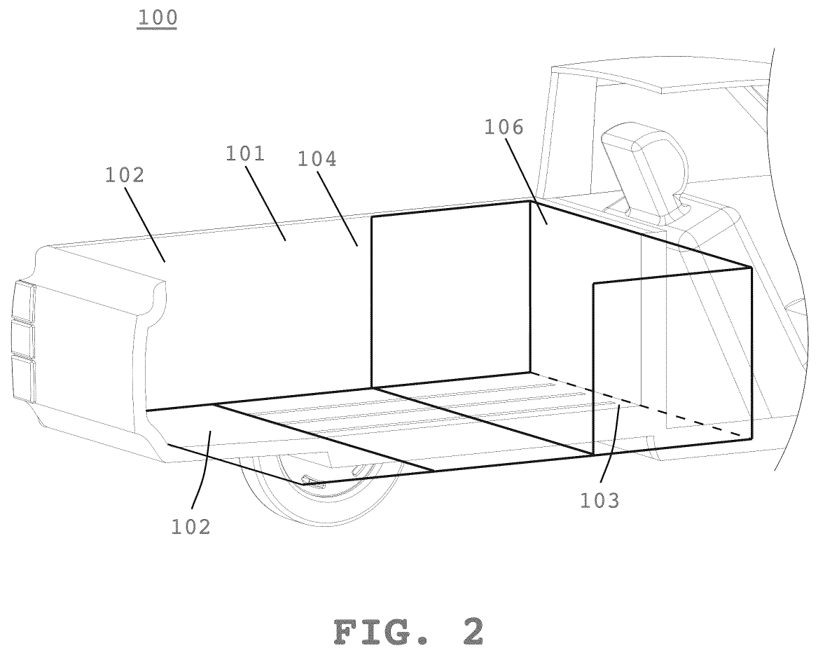

FIG. 2 illustrates the system 101 arranged in a second mode serving the function of a cargo bed liner. In the second mode, at least one panel 104 lays against the base of cargo bed 103. In some embodiments of the second mode, additional panels lay in contact with sidewall 102 and/or a midgate 106.

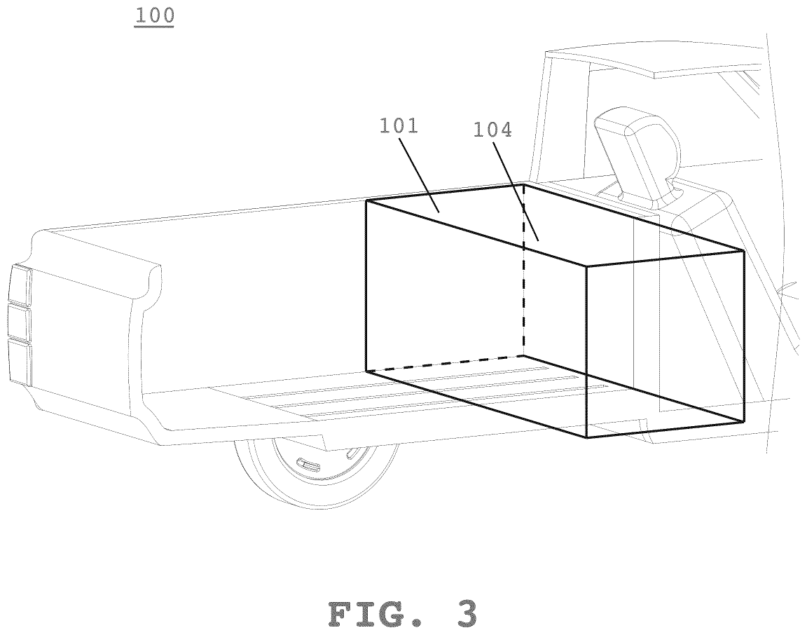

FIG. 3 illustrates the system 101 arranged in a third mode serving the function of a storage box. In the third mode, at least five of panels 104 are arranged and connected to form a box which may be used to store and organize cargo. In the third mode, the box may have an open top or closed top by arranging additional panels 104 the top of the box as a lid. While in FIG. 3 the system 101 is depicted as a rectangular box, the box may be arranged in different shapes by changing the size and number of panels. In the third mode, the system 101 may be placed in the cargo bed, in the cabin interior, or may be removed from the vehicle.

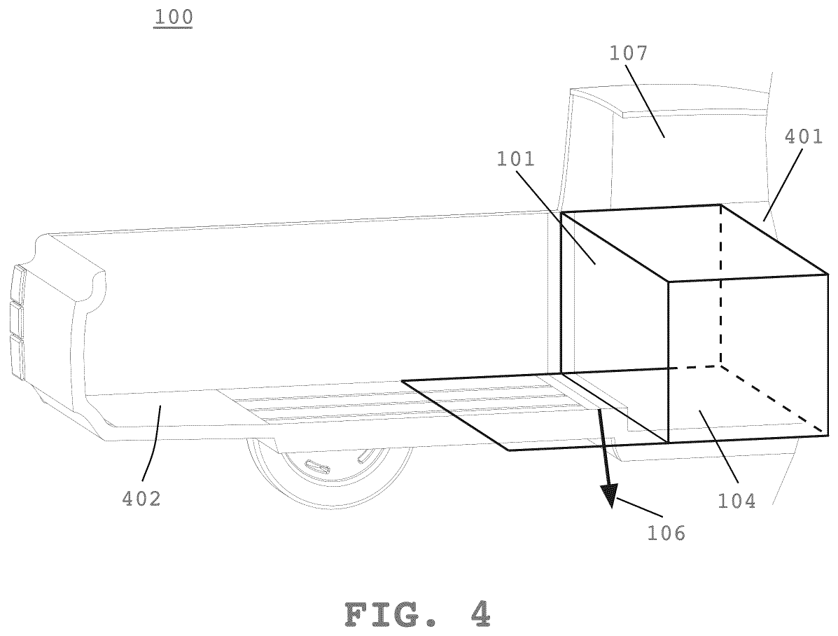

FIG. 4 illustrates the system 101 arranged in a fourth mode serving the function of a cabin protector. In a vehicle 100 where the midgate 106 is removeable, folding, or retracts, the cabin is opened the cargo bed in order to extend the cargo storage capacity of the cargo bed. In the fourth configuration, at least one panel 104 lays against the interior 401 of cabin 107. In some embodiments, an additional panel 104 extends onto the base 402 of cargo bed 103. In some embodiments, additional panels 104 may be placed in contact with cabin interior walls or seatbacks to protect the interior. In some embodiments, the panels 104 inside the interior 401 may be arranged and connected to form a box.

The system 101 may have additional modes. In a variation of the first mode, the bed may be partially or fully covered by panels. In a variation of the second mode, at least one panel 104 may be raised and connected to form a partition in the cargo bed 103. In a variation of the first or second modes, at least one panel 104 may be placed over the sidewall 102 or tailgate 108 of cargo bed 103 in order to protect the exterior of the sidewall 102 or tailgate 108. In an additional mode the system 101 may be removed from vehicle 100 and used as a mat exterior to the vehicle.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A multifunctional protection and storage system for a vehicle, comprising:
at least two panels; and
at least one hinge connecting two of the at least two panels;
wherein the at least two panels are configured to be arranged in at least two modes selected from a group consisting of:
a cargo bed cover mode,
a cargo bed liner mode,
a storage box mode, and
a cabin protection mode.

2. The multifunctional protection and storage system of claim 1, further comprising at least two fasteners formed on edges of the at least two panels, the fasteners configured to selectively connect two of the at least two panels.

3. The multifunctional protection and storage system of claim 1, wherein the at least one hinge is a living hinge made of a same material as the at least two panels.

4. The multifunctional protection and storage system of claim 1, wherein in the cargo bed cover mode the at least two panels are arranged with at least one of the panels spanning a vehicle cargo bed of the vehicle.

5. The multifunctional protection and storage system of claim 4, wherein in the cargo bed cover mode the at least two panels are further arranged with at least one of the panels in contact with a sidewall of the vehicle cargo bed.

6. The multifunctional protection and storage system of claim 1, wherein in the cargo bed liner mode the at least two panels are arranged with at least one of the panels in contact with a vehicle cargo bed of the vehicle.

7. The multifunctional protection and storage system of claim 6, wherein in the cargo bed cover mode the at least two panels are further arranged with at least one of the panels in contact with a sidewall of the vehicle cargo bed.

8. The multifunctional protection and storage system of claim 1, wherein in the storage box mode the at least two panels comprise at least five panels arranged and connected to form a box.

9. The multifunctional protection and storage system of claim 8, wherein in the cargo bed cover mode the at least five panels are connected by the at least one hinge and by at least one fastener.

10. The multifunctional protection and storage system of claim 1, wherein in the cabin protection mode the at least two panels are arranged with at least one of the panels in contact with an interior of a cabin of the vehicle.

11. The multifunctional protection and storage system of claim 10, wherein in the cabin protection mode the at least two panels are further arranged with at least one of the panels in contact with a vehicle cargo bed of the vehicle.

12. The multifunctional protection and storage system of claim 11, wherein in the cabin protection mode the at least two panels are further arranged inside the cabin interior to at least partially form a box.
